(19) United States
(12) Patent Application Publication
(10) Pub. No.: US 2004/0231325 A1
(43) Pub. Date: Nov. 25, 2004

(54) Vehicle vacuum system and method

(76) Inventor: Gary A. Nichols, Farmington Hills, MI (US)

Correspondence Address: Vincent A. Cichosz, Delphi Technologies, Inc., M/C 480-410-202, P.O. Box 5052, Troy, MI, 48007-5052, US

(21) Appl. No.: 10/444,580

(22) Filed: May 23, 2003

(51) Int. Cl. F16D 31/02

(52) U.S. Cl. 60/297

(57) ABSTRACT

In one embodiment, a brake system comprises: a means for accumulating a vacuum pressure capable of being disposed in operable communication with a means for creating a vacuum pressure in an engine, and a means for directing a vacuum pressure produced by the means for creating a vacuum pressure, wherein the a means for directing comprises a means for controlling a pressure flow that is capable of being disposed less than or equal to about 150 millimeters from the means for creating, and is adapted to be responsive to a pressure pulse.

### BACKGROUND

The disclosure relates to vehicular vacuum power systems, and especially relates to a vehicular vacuum power system in which a pressure difference between a vacuum and atmospheric pressure is utilized as a primary or auxiliary power source for a vacuum powered actuator, such as in a power-assisted braking system.

A conventional brake system for a motor vehicle typically operates by receiving an input braking force by the application of an operator's foot against a brake pedal and transforming that applied force into a hydraulic force that actuates the hydraulic actuators of the wheel braking mechanism. Many vehicles additionally provide a brake assist system in which the force applied to the brake pedal by the operator is amplified by a preset gain and the amplified force is transferred to the hydraulic brake system. The effect of this arrangement is to reduce the effort required by the driver to actuate the vehicle brakes.

In order to reduce the force required to operate a brake pedal during the braking operation, the typical hydraulic braking system of an automotive vehicle is commonly provided with a booster unit, which utilizes compressed air, intake manifold vacuum (for a vacuum booster), or hydraulic pressure (for a hydraulic booster) as a power source.

Engine manifold vacuum-actuated brake boosters are well known in the industry and have been used in automotive vehicles for many years. Essentially, vacuum brake boosters utilize the manifold vacuum of the vehicle engine to establish the pressure differential within the booster. Brake boosters generally comprise a booster housing having a single power piston which is axially movable by differential pressure. The power piston is connected with a single or a plurality of diaphragms. The diaphragm(s) separate the booster housing into vacuum chamber(s) and variable pressure chamber(s). The diaphragm(s) is flexible and usually is fabricated from a polymeric substance such as rubber, and has an inner position secured to the power piston. A valve mechanism for the booster is provided for admitting atmospheric air into the variable pressure chamber(s) (the variable pressure chamber normally is at vacuum pressure when the booster is in the release position) to actuate the booster.

In a typical spark ignition internal combustion engine, fuel is injected into an intake passage from a fuel injector valve to charge a homogeneous mixture of fuel and air to the associated combustion chamber. The homogeneous air-fuel mixture is ignited by an ignition spark plug to produce engine torque. A conventional vacuum brake booster utilizes vacuum that is produced in the intake passage downstream of the throttle valve as a drive source. Vacuum is communicated with the brake booster through a communicating pipe connected to the downstream side of the throttle valve, and, corresponding to the degree of depression of the brake pedal, acts on a diaphragm incorporated in the brake booster and increases the force actuating the brake.

Intake manifold vacuum is commonly used as a power source for motor vehicle actuators, including brakes, ventilation, cruise control, and engine tuning valve controls. Vacuum is a by-product of most internal combustion engines and is available in fairly large quantities at no cost. The vacuum generated by an engine is necessary to regulate the engine power, but it requires work. Many new engine technologies are being introduced that increase fuel efficiency but reduce the vacuum available in the intake manifold to power the various vacuum powered actuator systems. Consequently, under certain engine conditions, the vacuum generated by the engine is not sufficient to provide the power required in the various systems. For example, in a vacuum power assisted braking system reduced available vacuum under certain engine conditions may be insufficient to provide the proper degree of brake feel for the vehicle operator. Hence, the operator may be required to push hard on the brake pedal in order to bring the vehicle to a stop. One such condition occurs when an electronically controlled throttle (ETC) fails and the throttle is opened mechanically to a part throttle position to accommodate a “limp-home” capability by modulating engine power with cylinder cutoff and spark advance. In such a mode, the engine vacuum at idle is much lower than at a normal engine idle. Other conditions creating a low vacuum condition include such situations as operation of the vehicle at a high altitude, utilizing a high air conditioning load, using large amounts of exhaust gas recirculation (EGR), variable cam phasing, and employing lean burn engine systems.

Check valves and vacuum accumulation typically is used for power assisted brake systems and also commonly is used for all other vacuum actuators of the vehicular vacuum power systems. As an example in a typical braking system, the accumulator is designed to provide a vacuum boost for 2 or 3 pedal presses after the available engine vacuum no longer is adequate. This arrangement thus allows brake boost for a short time under engine conditions providing reduced available vacuum (e.g., at wide open throttle, if the engine stops running, or if a vacuum hose becomes disconnected). Most vacuum actuators also are designed to conserve their vacuum power source. Such actuators generally only use the vacuum when they are changing position. Accordingly, referring to the brakes as an example, it is the pressing and releasing of the brake pedal by the operator that depletes the vacuum, not holding the pedal.

However, the accumulators have very limited capacity to store vacuum, especially for a large vacuum power consumer like the braking system. Even with the use of typical accumulators, the braking system still requires the engine vacuum source to be adequate for most of the time that the vehicle is running. As engine technologies are introduced that lower the vacuum available under normal operating conditions, it will be increasingly difficult to supply adequate vacuum to maintain operation of vehicular vacuum power systems. The alternative of incorporating a separate vacuum pump system would be costly and energy inefficient.

### SUMMARY

Now, methods for operating a vehicle vacuum system, vehicle vacuum systems, and brake systems are provided. In one embodiment, a vehicle vacuum system comprises: an engine cylinder including a piston in mechanical communication with a piston rod, wherein the cylinder has a combustion area, an intake port with an intake valve, and an exhaust valve, a vacuum port disposed in operable communication with the cylinder, wherein the vacuum port is located in fluid communication with the intake port and is in fluid communication with a pressure accumulator, and a check valve disposed less than or equal to about 150 mm from the intake port, wherein the check valve has an open response time of less than or equal to about 25 ms.

In one embodiment, a method for operating a vehicle vacuum system comprises: introducing fuel to an engine cylinder, combusting the fuel, forming an engine vacuum, opening a check valve when the engine vacuum pressure exceeds an accumulator vacuum pressure, wherein the check valve is less than or equal to about 150 mm from an intake port in the cylinder and in fluid communication with a pressure accumulator, and closing the check valve when the engine vacuum pressure is less than the accumulator vacuum pressure, wherein the check valve has an open/close response time of less than or equal to about 25 ms.

In one embodiment, a brake system comprises: a means for accumulating a vacuum pressure capable of being disposed in operable communication with a means for creating a vacuum pressure in an engine, and a means for directing a vacuum pressure produced by the means for creating a vacuum pressure, wherein the a means for directing comprises a means for controlling a pressure flow that is capable of being disposed less than or equal to about 150 millimeters from the means for creating, and is adapted to be responsive to a pressure pulse.

The above-described and other features will be appreciated and understood by those skilled in the art from the following detailed description, drawings, and appended claims.

### BRIEF DESCRIPTION OF THE DRAWINGS

Referring now to the drawings, wherein like elements are numbered alike in the several figures:

FIG. 1 is a simplified schematic of a cylinder arrangement of an engine including a vacuum port for a vacuum booster;

FIG. 2 is a graph plotting the vacuum available near the intake valve during a cycle of a typical spark ignition internal combustion engine; and

FIGS. 3-8 are graphical illustrations of intake manifold pressure (MAP) at various engine speeds and load conditions.

### DESCRIPTION OF THE PREFERRED EMBODIMENT

Disclosed are systems for augmenting the amount of vacuum available in an engine, e.g., a spark ignition internal combustion engine, for vacuum powered actuators such as in a power-assisted braking system, and the like.

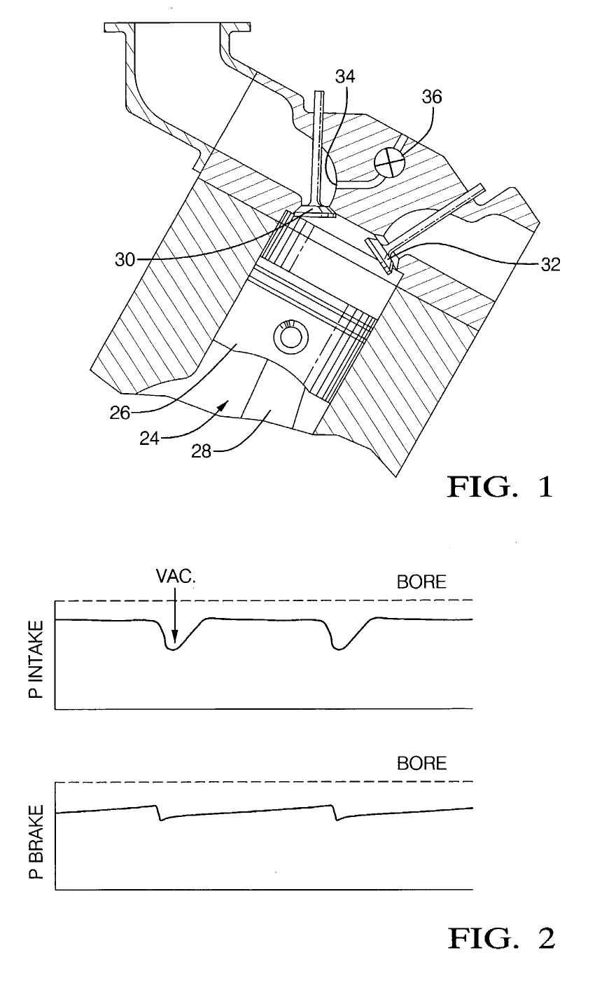

FIG. 1 depicts a cylinder arrangement for an engine, comprising an inlet valve 30, an exhaust valve 32, and a cylinder 24 including a piston 26 connected to piston rod 28. A port 34 for the vacuum booster is located near the inlet valve 30 of the cylinder 24. In another embodiment, the vacuum tap booster may be located in a runner to one or more cylinders, particularly in arrangements where this is the easiest location for packaging and casting. The distance from the vacuum tap (e.g., the fast response check valve) to the intake port on the cylinder may be less than or equal to about 250 millimeters (mm). Preferably, the distance is about 25 mm to about 250 mm. Preferably, within this range, the vacuum tap (e.g., the fast response check valve) is positioned greater than or equal to about 50 mm from the intake valve. Also preferred within this range, positioning of the vacuum tap less than or equal to about 150 mm from the intake valve, with less than or equal to about 100 mm more preferred.

As shown in FIG. 1, a low mass check valve or reed valve 36 within a port may be used to allow each intake event on the cylinder to increase the vacuum in the brake booster. The check valve 36 closes during the time of the engine cycle when the vacuum in the intake port is low. This arrangement may be replicated for as many cylinders as may be desired to generate the desired degree of vacuum for the booster of the vacuum powered actuators (e.g., the braking system). Typically, a check valve is located at a distance of about 300 mm or greater from the engine (e.g., the engine intake port) because the check valve is packaged in the brake booster. The check valve 36, however, is preferably located close to the engine (e.g., within about 50 mm) to take advantage of the pressure variation within the engine. For example, a hole could be cast or drilled in the sidewall of the passage. The diameter could be selected to flow sufficient air without pressure drop, but not be so large as to promote deposit buildup on the check valve from combustion gases in the intake passage.

FIG. 2 shows a plot of the raw vacuum available near the intake valve of a typical spark ignition internal combustion engine. As depicted in the top graph, the intake pressure will vary significantly with each engine cycle. When the intake valve is open and the piston is moving down, the pressure will be lowest (vacuum highest). By having a check valve that can open during this time, it is possible to achieve a higher vacuum in an accumulator than would be otherwise possible. The vacuum in the accumulator would be close to the peak vacuum at the port at each engine cycle. As can be seen from the lower graph, when the vacuum tap is located close to the intake valve, for a portion of each engine cycle, the vacuum is significantly greater than the average vacuum in the intake manifold. By using a check valve with fast response (i.e., capable of opening when the pressure dips (e.g., a response time of less than or equal to 10 milliseconds)), it is possible to increase the vacuum in an accumulator higher than the average vacuum in the intake manifold. The check valve can open during the times of highest vacuum, pulling air out of the accumulator.

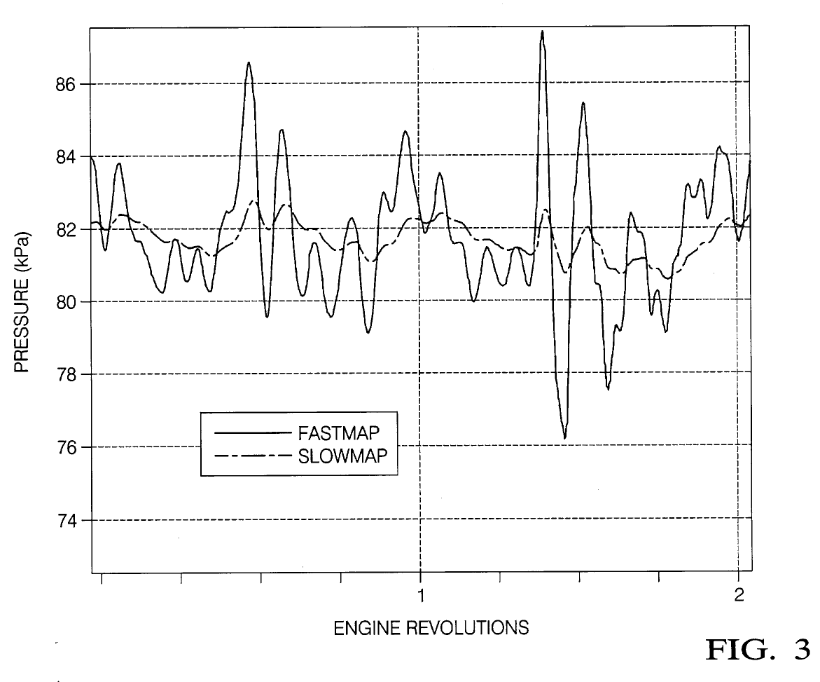

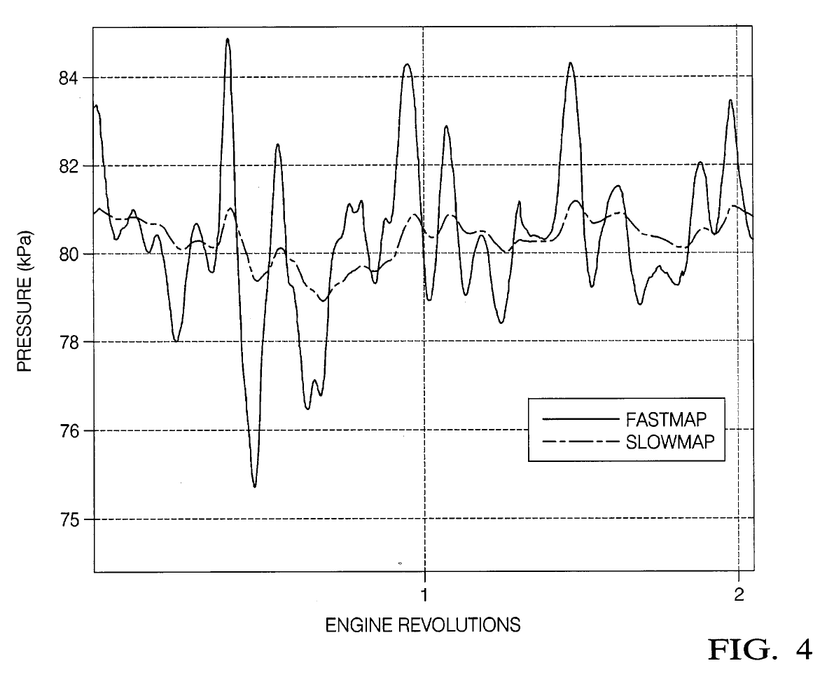

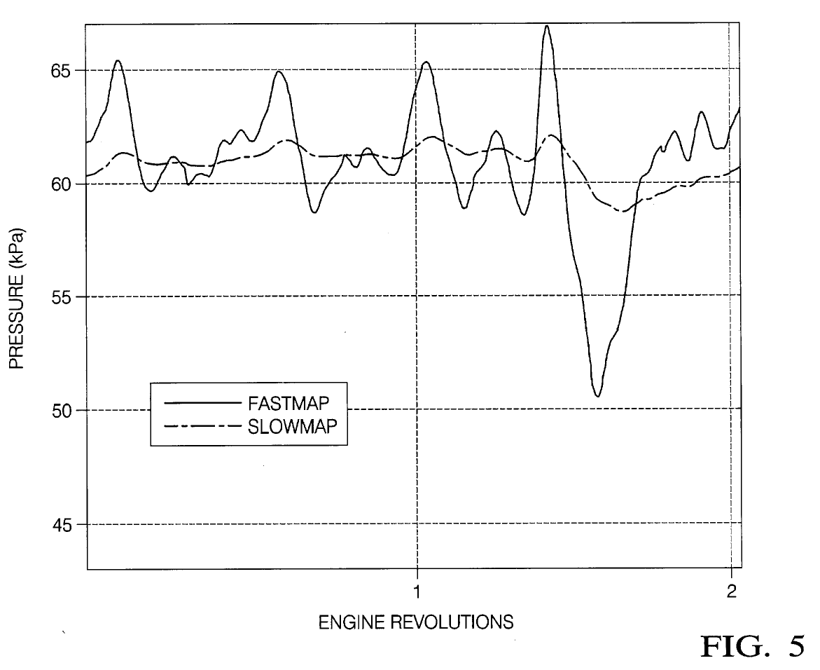

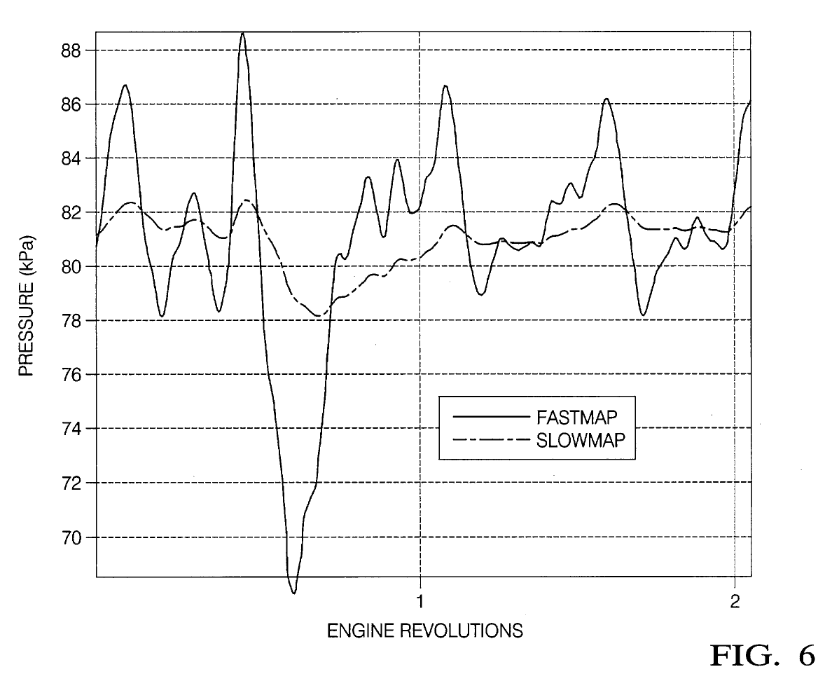

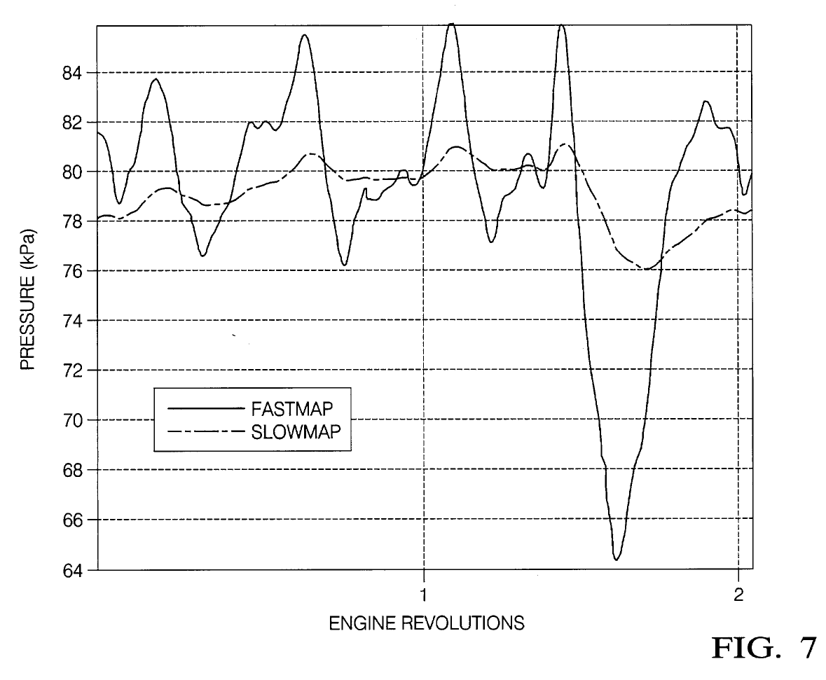

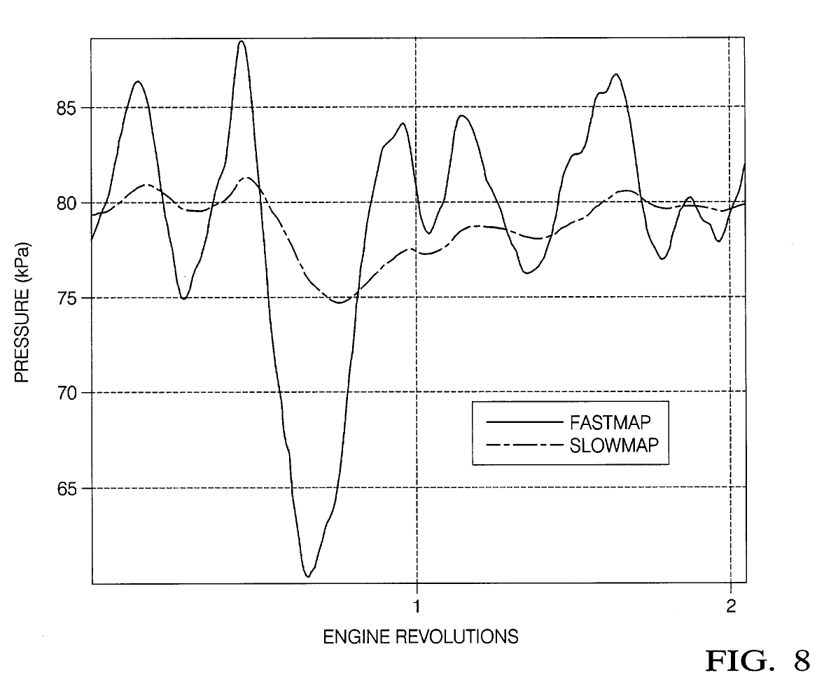

FIGS. 3-8 are graphical illustrations of pressure (kilopascals(kPa)) over time (seconds(sec)), i.e., the intake manifold pressure (MAP) at various engine speed and load conditions. The Fastmap signal is from a normal pressure sensor (which has good frequency response) getting the pressure reading through a 4 cm long tube connected to a tap in the manifold that is located in the runner for one cylinder. Each plot is for 2 engine revolutions (i.e., 1 engine cycle). When the intake valve on the nearby cylinder opens, the pressure drops (vacuum increases). This data, as is also illustrated in the Table, shows that there is a greater pulsation of pressures at higher engine speeds.

TABLE

| Engine Speed (RPM) | Delta Pressure (kPa)) |
|---|---|
| 1,500 | 5-6 |
| 2,000 | 6 |
| 3,500 | 10 (at medium load) |
| 3,500 | 14 (at high load) |
| 4,000 | 16 |
| 4,500 | 18 |

Optionally, a slow response check valve can be employed in the standard location near the brake booster as well as the fast responding check valve near the engine. The slow response check valve is typically located greater than or equal to about 300 mm from the intake port, with a distance of less than or equal to about 150 mm from the brake booster preferred. The slow check valve would be needed to maintain a very low leak rate when the engine is off, while the fast check valve could be optimized for speed since the slow response check valve is not responsive enough to react to a pressure pulse.

Essentially, slow check valves are generally located in the brake booster (e.g., an open/close response time of greater than 100 (milliseconds (ms), with greater than 100 ms typical). The engine vacuum at the check valve does not vary much with each engine cycle (e.g., 2 crankshaft revolutions) because the vacuum comes from the plenum part of the intake manifold and travels down a long tube. The result is that the vacuum in the accumulator will be close to the average vacuum in the intake manifold under steady running conditions.

In order to increase the vacuum in the accumulator, the manifold tap is located in a place where the vacuum changes a lot every engine cycle and uses a fast check valve (e.g., an open/close response time of less than or equal to about 25 ms). Preferably, the fast check valve has an open/close (i.e., an open and/or a close) response time of less than or equal to about 10 ms. The valve opens when the vacuum in the engine exceeds the vacuum in the vacuum accumulator/brake booster and then closes when the vacuum in the engine decreases below the vacuum in the vacuum accumulator/brake booster. The net result is that the vacuum pressure in the accumulator will not be the average of the engine vacuum pressures, but will be closer to the maximum vacuum pressure seen each engine cycle. For example, if the engine vacuum pressure at a normal running condition is 40 kPa and the maximum vacuum pressure seen each engine cycle is 50 kPa, there is the potential to increase the vacuum pressure in the break accumulator 25%, namely from 40 kPa to 50 kPa. Due to the present design, the vacuum in the accumulate can be greater than or equal to about 80% of the peak engine vacuum pressure, with greater than or equal to about 85% of the peak engine vacuum pressure possible, greater than or equal to about 90% of the peak engine vacuum pressure preferred, and greater than or equal to about 95% of the peak engine vacuum pressure attainable.

While the invention has been described with reference to an exemplary embodiment it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A vehicle vacuum system, comprising:
an engine cylinder including a piston in mechanical communication with a piston rod, wherein the cylinder has a combustion area, an intake port with an intake valve, and an exhaust valve;
a vacuum port disposed in operable communication with the cylinder, wherein the vacuum port is located in fluid communication with the intake port and is in fluid communication with a pressure accumulator; and
a check valve disposed less than or equal to about 150 mm from the intake port, wherein the check valve has an open response time of less than or equal to about 25 ms.

2. The system of claim 1, wherein the open response time is less than or equal to about 10 ms.

3. A method for operating a vehicle vacuum system, comprising:
introducing fuel to an engine cylinder;
combusting the fuel;
forming an engine vacuum;
opening a check valve when the engine vacuum pressure exceeds an accumulator vacuum pressure, wherein the check valve is less than or equal to about 150 mm from an intake port in the cylinder and in fluid communication with a pressure accumulator; and
closing the check valve when the engine vacuum pressure is less than the accumulator vacuum pressure;
wherein the check valve has an open/close response time of less than or equal to about 25 ms.

4. The method of claim 3, wherein the accumulator vacuum pressure is greater than or equal to about 80% of a peak engine vacuum pressure.

5. The method of claim 4, wherein the accumulator vacuum pressure is greater than or equal to about 85% of the peak engine vacuum pressure.

6. The method of claim 5, wherein the accumulator vacuum is pressure greater than or equal to about 90% of the peak engine vacuum pressure.

7. The method of claim 6, wherein the accumulator vacuum pressure is greater than or equal to about 95% of the peak engine vacuum pressure.

8. The method of claim 7, further comprising employing the accumulator vacuum pressure to operate power brakes.

9. The method of claim 3, wherein the open response time is less than or equal to about 10 ms.

10. A brake system, comprising:
a vacuum accumulator in operable communication with an actuating piston in an engine cylinder;
a conduit including a fast response check valve adapted to permit airflow in one direction, from the engine cylinder, wherein the fast response check valve has an open response time of less than or equal to about 25 ms; and
a cylinder head including a combustion chamber, an intake valve, a valve bowl area, and an intake runner portion, wherein the cylinder head is adapted to receive a first end portion of the conduit at a location suitable for transmitting a vacuum generated during engine operation through the conduit, and wherein the second end portion of the conduit is in fluid communication with the inlet provision on the vacuum accumulator.

11. The system of claim 10, wherein the first portion of the conduit is connected to the valve bowl area.

12. The system of claim 10, wherein the first portion of the conduit is connected to the intake runner.

13. The system of claim 10, wherein the open response time is less than or equal to about 10 ms.

14. The system of claim 10, further comprising a slow response check valve disposed near the vacuum accumulator, and wherein the fast response check valve is disposed near the engine.

15. The system of claim 14, wherein the fast response check valve is disposed less than or equal to about 150 millimeters from the intake valve.

16. The system of claim 15, wherein the fast response check valve is disposed less than or equal to about 50 millimeters from the intake valve.

17. The system of claim 14, wherein the slow response check valve is disposed greater than or equal to about 300 millimeters from the intake valve.

18. A brake system, comprising:
a means for accumulating a vacuum pressure capable of being disposed in operable communication with a means for creating a vacuum pressure in an engine; and
a means for directing a vacuum pressure produced by the means for creating a vacuum pressure, wherein the a means for directing comprises a means for controlling a pressure flow that is capable of being disposed less than or equal to about 150 millimeters from the means for creating, and is adapted to be responsive to a pressure pulse.

19. The system of claim 18, wherein the means for directing is disposed less than or equal to about 50 millimeters from the means for creating.

20. The system of claim 18, wherein the means for directing has an open response time of less than or equal to about 10 ms.
